(19) United States
(12) Patent Application Publication
(10) Pub. No.: US 2011/0258240 A1
(43) Pub. Date: Oct. 20, 2011

(54) SYSTEM AND METHOD FOR POPULATING AND MANAGING A COMPUTER DATABASE OF DISCRETE, CATEGORIZED SEGMENTS OF SEQUENTIAL TEXT

(76) Inventors: Larry D. LeFever, New York, NY (US); Matthew N. Kaplan, New York, NY (US); Charles C. Wu, Mountain View, CA (US)

(21) Appl. No.: 13/090,176

(22) Filed: Apr. 19, 2011

Related U.S. Application Data
(60) Provisional application No. 61/325,422, filed on Apr. 19, 2010.

(51) Int. Cl. G06F 17/30

(52) U.S. Cl. 707/812; 707/E17.005

(57) ABSTRACT

A system and method for populating a computer database of discrete, categorized segments of sequential text, and for iteratively reviewing, editing, reordering, or deleting the database's contents, including by use of markers to delineate the text segments' boundaries and by use of an overlay tool to measure text segments.

### CROSS-REFERENCE TO RELATED APPLICATIONS

This Application incorporates by reference and claims all rights of priority to Provisional Patent Application No. 61/325,422 filed on Apr. 19, 2010.

### RESERVATION OF COPYRIGHT

Portions of this patent document contain material which is subject to copyright protection. Among other such material, a “computer program listing” in accordance with 37 CFR §1.96 is contained herein that lists source code instructions for processes by which the present invention may be practiced. The copyright owner has no objection to the facsimile reproduction by anyone of the patent document as it appears in the Patent and Trademark Office patent file or records, but otherwise reserves all copyright rights whatsoever.

### BACKGROUND OF THE INVENTION

I. Field of the Invention

This invention relates generally to computer software and database systems. More particularly it relates to user interfaces and tools for populating computer databases with categorized and sequenced text segments and for managing such databases' contents.

II. Prior Art

Computer database systems are important. They are a primary means by which society gathers, stores, and manipulates information, especially information that is voluminous or must be rapidly accessible.

Most databases in use are relational databases. Although relational database systems are powerful and flexible, they unfortunately remain difficult to use in too many contexts. They often must be administered through complicated formal instructions in languages such as SQL (Structured Query Language), or through complicated graphical user interfaces provided by software programs such as phpMyAdmin or pgAdmin. It is difficult and time consuming to obtain proficiency in such methods. It continues to be important, therefore, to develop simpler methods of database management.

One specific type of database, for which relational database systems are well suited, enables a user to store discrete segments of text with associated information about each segment's place in a sequence or hierarchy, and enables the user to group the segments by categories and subcategories. Numerous computer software applications may be supported by this type of database. One example is an application for parallel transmission in multiple languages of subtitles to a movie, television program, or live theatrical performance. Another example is an application for display of appropriate advisories and directives for motorists at each of multiple geographic points within a vehicular traffic system.

Certain features of such applications may be accomplished on a limited basis by existing varieties of slide presentation program. A slide presentation program is a computer program that enables a user, among other things, to create and store sequential segments of text, to retrieve and edit the segments, and to display them as a “presentation.” (Widely available slide presentation programs include Microsoft's PowerPoint, Apple's Keynote, and OpenOffice's Impress.)

One limitation of existing slide presentation programs is that they do not store text segments in relational databases, but rather within flat files using either proprietary binary file formats (such as PowerPoint's .ppt files or Keynote's .key files) or XML-based file formats (such as PowerPoint's Office Open XML, or OpenDocument used by Impress). These storage methods hamper the scope and flexibility of uses to which the text segments may be put once they have been stored in this manner, as recognized in a different but analogous context by U.S. Pat. No. 6,938,032 B1 to Heath et al. (2005). The flexibility of relational database models, especially regarding the administration of associations among data objects, and the ability to scale and support concurrent use by a plurality of users, is not available with flat files.

A second and related limitation of existing slide presentation programs is that although they enable text segments to be grouped by “presentation,” they provide no convenient facility to administer a plurality of presentations. So, for example, while a user could prepare Spanish subtitles for Hamlet as one “presentation,” French subtitles for Hamlet as another presentation, and so on in additional languages, no facility would exist to link the multilingual Hamlet subtitle presentations for convenient parallel editing or display, or for convenient processing by users who wish to access the stored data in other applications.

Another limitation of existing slide presentation programs is that their user interfaces do not permit a user to place boundary markers within long passages of plain text to divide the text into smaller segments. Nor do they enable users to adjust the segments' size by reference to measurement tools while placing such boundary markers.

Therefore, it is desirable to provide a mechanism and process for a user conveniently and efficiently to populate and manage a relational database of discrete segments of text and associated sequential and hierarchical information. Preferably, such a mechanism will enable the user to designate and manipulate categories and subcategories of text segments, and to alter the sequence of text segments within specific category or subcategory combinations. A preferable mechanism will also provide convenient means for a user to manipulate longer passages of text by placing boundary markers to divide the passages into appropriately measured smaller segments, and to adjust the boundary markers' positions as may be needed upon iterative viewing, editing, and measurement.

### REFERENCE TO COMPUTER PROGRAM LISTING

A computer program listing is included at the end of this disclosure and is incorporated herein by reference.

### SUMMARY OF THE INVENTION

In one general aspect of the invention, a method for populating a computer database with discrete, categorized segments of sequential text is provided. Generally, the method includes providing a computer database management facility within a computer-based operating environment that includes access to a recording medium operable for database storage, and configuring this database management facility to provide a database to store a plurality of discrete text segments. The method further includes providing a means to store at least one category definition and at least one member for each category definition. The method further includes providing a means to associate each of the discrete text segments with a set that includes one member of each category definition, and with a sequence number that is shared by no other text segment associated with this set. The method further includes steps of providing a means to populate the database with at least one category definition, providing a means to populate the database with at least one member of each category definition, and providing a means for an end-user to populate the database with a plurality of text segments. In this latter step, the end-user designates the set of one member of each category definition, and presents to a processing facility a text passage that includes a marker signifying boundaries of the text segments within the text passage, the marker being positioned at various intervals. Subsequently, the processing facility divides the text passage into text segments in accordance with the boundaries defined by the positions of the marker, and populates the database with the text segments such that each text segment is associated with the set of one member of each category definition designated by the end-user. For each text segment, the processing facility also populates the database with the associated sequence number.

The above aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

The invention is illustrated by way of example and not limitation and the figures of the accompanying drawings in which like references denote like or corresponding parts, and in which:

FIG. 1 shows a schematic for the structure of an exemplary relational database.

FIG. 2 shows a schematic of an exemplary graphical user interface.

FIG. 3 shows the schematic of an exemplary graphical user interface after the user has selected a category and a subcategory.

FIG. 4 shows the schematic of an exemplary graphical user interface after the user has input an exemplary text passage into the interface.

FIG. 5 shows the schematic of an exemplary graphical user interface after the user has input boundary markers to delineate text segments within the exemplary text passage.

FIG. 6 shows the schematic of an exemplary graphical user interface after the exemplary text passage has been processed and returned as an enumerated sequence of text segments.

FIG. 7 shows an exemplary measurement overlay displayed within the schematic of an exemplary graphical user interface.

FIG. 8 shows interior reference marks displayed within the exemplary measurement overlay.

### DETAILED DESCRIPTION OF THE INVENTION

The present invention is in large part described herein with respect to an example of a preferred embodiment. The example should not be construed as limiting. Variations will occur to those of ordinary skill in the art that remain within the scope and spirit of the invention. For example: data storage methods or locations, file types, markup and style-sheet languages, form elements, data transmission or networking protocols, client-server or network configurations, programming languages, and allocation of server vs. client operations may differ from those described herein without departing from the invention.¹ ¹ More generally, any thing or group of things referred to in this document as an “example,” “exemplary,” or “for example,” or introduced by the term “such as,” is included for purposes of illustration, and not to indicate that other, equally illustrative things, do not exist.

### I. Operating Environment

A. Computer System

An exemplary operating environment for the invention includes² a general purpose computer system. This encompasses an apparatus with components that include a central processing unit, memory, an operating system software application, data storage capacity, and a combination of input/output devices, including a screen or other display medium, a keyboard, or a pointing and signaling facility such as a mouse, trackpad, trackball, or touchscreen. ² As used in this patent document, the term “include,” in all its conjugations and forms, means “include without limitation.”

The computer system executes one or more computer programs, which are saved in data storage or memory mediums. The operating system is a computer program that performs basic tasks such as recognizing input from the keyboard, sending output to the display screen, keeping track of files and directories in data storage and memory, and controlling peripheral devices such as disk drives and printers. Computer programs known as application software can run on top of the operating system to provide additional functionality.

B. Browser

The computer system is capable of running a browser. A browser is a software application that enables its user, among other things, to locate, display, and interact with text files. Through an appropriate communication protocol such as the HyperText Transfer Protocol (“HTTP”), a browser can “download” or access such files whether they are stored locally (on the same computer as the browser) or remotely (on a separate computer). A browser can locate and request to download a file by reference to the file's Uniform Resource Identifier (“URI”).³ A browser also can “upload” or transmit data locally or to a remote computer through an appropriate communication protocol such as HTTP. ³ See, e.g., T. Berners-Lee, R. Fielding, L. Masinter, Uniform Resource Identifier (URI): Generic Syntax, Request For Comments 3986, The Internet Society (2005), available at http://www.ietf.org/rfc/rfc3986.txt (last accessed Mar. 15, 2010).

Browsers also render structured document files. A “structured document file” is a text file that, among other things, has been coded or annotated with a markup language. A markup language provides instructions for how text should be structured or formatted upon display. A browser “renders” a structured document file by displaying it in accordance with the browser's interpretation of such instructions. One example of a markup language is the HyperText Markup Language (“HTML”), which is an instance of SGML (Standard Generalized Markup Language).⁴ ⁴ See generally World Wide Web Consortium (“W3C”), HTML 4.01 Specification, Dec. 24, 1999, available at http://www.w3.org/TR/html401/(hereinafter “HTML 4.01 Specification”) (last accessed Mar. 11, 2010).

In rendering structured document files, browsers also can interpret style-sheet languages. Style-sheet languages are a means to provide directions to the browser about how to apply the markup language in which a structured document file is coded, including by specifying various style and formatting parameters.⁵ Examples include Cascading Style Sheets (“CSS”) and Extensible Stylesheet Language (“XSL”).⁶ ⁵ See, e.g., HTML 4.01 Specification, supra note 4, §14 (Style Sheets), available at http://www.w3.org/TR/html401/present/styles.html.⁶ See, e.g., W3C, Cascading Style Sheets, Level 2 Revision 1 (CSS 2.1) Specification, W3C Candidate Recommendation, Sep. 8, 2009, available at http://www.w3.org/TR/CSS2/(last accessed Mar. 15, 2010); W3C, Extensible Stylesheet Language (XSL) Version 1.1, W3C Recommendation, Dec. 5, 2006, available at http://www.w3.org/TR/xsl11/(last accessed Apr. 16, 2010).

Browsers widely available today include, for example, Firefox, Internet Explorer, Safari, Chrome, and Opera. It will be appreciated by one of ordinary skill in the art, however, that the invention may be practiced with other software applications. The term “browser,” as used in this patent document, refers to any software application capable of performing functions equivalent to the functions ascribed to browsers herein, whether or not those are the software application's primary functions.

C. HTML Forms

The HTML “form” element is a container for designating graphical user interface elements with which a browser may enable user interaction.⁷ ⁷ See generally HTML 4.01 Specification, supra note 4, §17 (Forms), available at http://www.w3.org/TR/html401/interact/forms.html#h-17.

HTML forms contain special HTML elements called controls. Each control has both an “initial value” in its initially rendered state, and a “current value” that a user may change from the initial value. A user “completes” a form by modifying its controls as needed to adjust their current values to match the user's preferences. The user then “submits” the form, which causes the browser to transmit the current values of the form's controls to an agent for processing (for example, to a Web server or email server).

There are a variety of HTML form controls. One is the “select” element, which presents a dropdown menu⁸ of choices, with each choice designated by an HTML “option” element. A select element must contain at least one option element. A select element may be pre-selected to have an initial default value designated by one of its option elements by setting that option element's “selected” attribute. ⁸ A dropdown menu presents a user with a list of values from which the user may choose. When inactive, it displays a single value. When activated by the user, it displays (“drops down”) the list. When the user has chosen from the list, the control reverts to its inactive state, displaying the value chosen by the user.

Another HTML form control is the “input” element, of which there are several “types”:
If an input element's type is specified as “text,” it designates a place for a user to input a single line of text.
An input element of type “textarea” designates a control for multiple lines of text input.
An input element of type “submit” creates a “submit button.” When “activated,” a submit button indicates that its containing form should be transmitted to the URI designated by that form's “action” attribute.⁹ ⁹ HTML 4.01 Specification, supra note 4, §17.13.3 (Processing Form Data), available at http://www.w3.org/TR/html401/interact/forms.html#h-17.13.3.
An input element of type “hidden” is not displayed by the browser, but its initial value will still be transmitted as part of its containing form's data set when the form is submitted by the user. The hidden control type thus provides a means to “store information between client/server exchanges that would otherwise be lost due to the stateless nature of” the HTTP protocol.¹⁰ ¹⁰ HTML 4.01 Specification, supra note 4, §17.2.1 (Control Types), available at http://www.w3.org/TR/html401/interact/forms.html#h-17.2.1.

D. Client-Side Scripting

A structured document file also may contain, or may import into itself from another location, one or more client-side scripts. A client-side script is a program or set of instructions that the browser (the “client”) executes upon downloading the associated structured document file, or upon a later triggering event, such as the user's activation of a hyperlink that has been programmed to indicate the client-side script should be run.¹¹ ¹¹ See, e.g., HTML 4.01 Specification, supra note 4, §18 (Scripts).
E. Server-Side Scripting

A structured document file also may contain, or may import into itself from another location, one or more server-side scripts. A server-side script is a program or set of instructions that is executed by the computer or software application (a “server”) that is transmitting (“serving”) the structured document file to the browser. The server's execution of the server-side script is prompted by the browser's request to download the structured document file.

F. Server

In the exemplary operating environment for the present invention, the computer system runs a server application (such as Apache, Microsoft IIS, Nginx, or an equivalent) (the “Server”). The Server is able to communicate based on one or more network communication protocols (such as HTTP, or an equivalent), and to execute or cause components of the computer system to execute, by means of a server-side scripting facility, programs written in a server-side scripting language (such as PHP, ASP, Perl, Python, or an equivalent). By execution of server-side scripts, the Server can format and transmit an HTML form to a browser, and also receive and process HTML form data transmitted to the Server by the browser.

G. Database

The computer system also runs a database management application, such as MySQL, Microsoft SQL Server, Oracle, PostgreSQL, or an equivalent. Data stored by the computer system by means of a database management application will be referred to herein as the “Database”.

### II. Database Structure

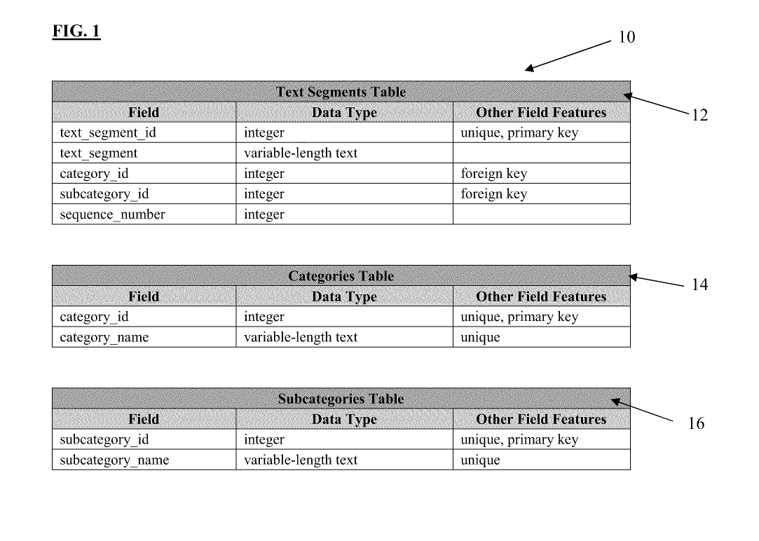

FIG. 1 is a schematic of an exemplary relational database structure for the Database 10. It includes a table for text segments (the “Text Segments Table”) 12, a table for categories of text segments (the “Categories Table”) 14, and a table for subcategories of text segments (the “Subcategories Table”) 16. The primary keys of the Categories Table 14 and Subcategories Table 16 serve as foreign keys in the Text Segments Table 12.¹² ¹² In relational database design, a primary key is a column or combination of columns in a database table that uniquely identifies each row in the table. A foreign key is a column in a database table that matches the primary key of another table and can operate as a referential constraint between the two tables.

In an exemplary use of this structure, the text segments could be subtitles, each category could be the name of a movie or play, and each subcategory could be a language. Further, the sequence number field of the Text Segments Table could represent each text segment's ordinal position within a specific movie/language combination.

In an alternative exemplary use of this structure, the text segments could be directives and advisories for motorists; the categories could be highway routes; the sequence number field could designate highway exits and other waypoints; and the subcategories could be weather conditions. The database structure also could be modified slightly to add a subcategory table for times of day, or other relevant parameters.

It will be recognized by one skilled in the art that the exemplary database structure may be adapted to many uses, and also that the structure may be modified in various ways, including by adding tables for other categories or subcategories, or adding fields for other sequences.

### III. The User Interface

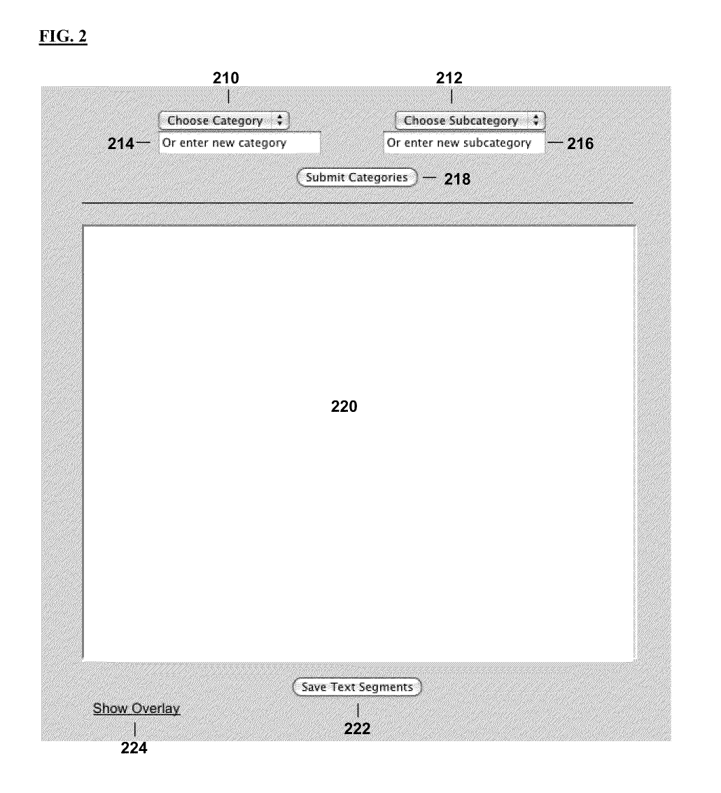

To populate the Database 10 with text segments, a user interacts with the Database through a graphical user interface (the “GUI”). FIG. 2 is a schematic illustration of an exemplary GUI. The included computer program listing (the “Listing”) presents pseudocode for a file (the “GUI File”) containing a mixture of server-side and client-side scripting instructions and HTML to implement the GUI.

The GUI File contains two HTML forms. The first form, named “categories” (Listing, lines 136-202) (the “Categories Form”), is for the user to specify a category/subcategory combination. Its HTML form controls consist of two select elements 210, 212, two input elements of type “text” 214, 216, and a single input element of type “submit” 218.

The second form, named “text_segments” (Listing, lines 204-231) (the “Segments Form”), is for mediating the user's management of text segments of a specified category and subcategory. Its visible HTML form controls consist of one input element of type “textarea” 220 for entering, viewing, and editing text segments, and one input element of type “submit” 222. The Segments Form also has two input controls of type “hidden,” which are not visible to the user. One is named “category_id” (Listing, line 225) and the other “subcategory_id” (Listing, line 228), and their purpose is to record and preserve the user's choice of category and subcategory.

The “action” attributes of both the Categories Form and the Segments Form designate the URI of the GUI File itself for the address of the forms' processing agent. Thus, when the user submits either form, its data set will be processed by the server-side scripting instructions contained within the same file as the form—i.e., within the GUI File itself.

The user accesses the GUI by providing the GUI File's URI to a browser (the “Browser”), causing the Browser to request the GUI File from the Server. In response, the Server retrieves the GUI File and parses and executes the server-side scripting instructions it contains (Listing, lines 1-33, 143-164, 170-192, 208-218, 225-226, 228-229). These instructions direct the Server to retrieve from the Database any categories or subcategories with which the Categories Table and Subcategories Table already have been populated, and to generate HTML markup to describe dropdown menus (the select controls of the Categories Form) with this information (Listing, lines 142-165, 169-193).

The Server transmits to the Browser the GUI File's HTML (Listing, lines 35 et seq. passim) and style instructions (Listing, lines 44-100), including any modifications generated by the Server's execution of the GUI File's server-side-scripting instructions. The Browser in turn renders the HTML it receives, and displays the GUI to the user (FIG. 2).

### IV. Choosing Categories

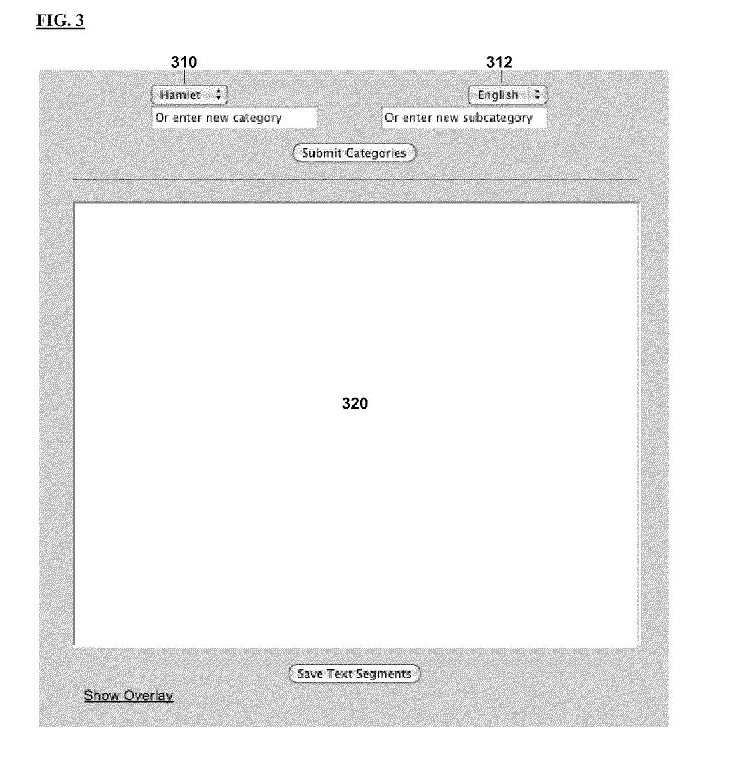

With the GUI's dropdown menus 210, 212, the user views the categories and subcategories with which the Database's Categories Table and Subcategories Table have been populated. The user may use the dropdown menus to choose which category/subcategory combination of text segments he wishes to administer FIG. 3, 310, 312. Alternatively, the user may enter the name of a new category or subcategory in the corresponding text input controls 214, 216. After choosing a category/subcategory combination, with the menus and/or the text input controls, the user then transmits his choice by activating the Categories Form's submit button control 218. This causes the Browser to transmit the Categories Form's data set to the Server, designating the GUI File itself as processing agent according to the form's “action” attribute (Listing, line 137).

Upon receiving the Categories Form's data set, the Server processes it according to the server-side scripting instructions contained in the GUI File. If the user has entered a new category or subcategory, the Server inserts that entry into the Database's Categories Table or Subcategories Table, as appropriate (Listing, lines 4-5). The Server also updates the GUI's select controls, by preselecting the appropriate “option” elements, so that the dropdown menus will display to the user the category/subcategory combination chosen by the user (Listing, lines 149-152, 176-180). To memorialize the user's choice of category and subcategory (i.e., to save “state”), the Server also updates the Segments Form's hidden input elements (Listing, lines 225-226, 228-229). Those with ordinary skill in the art will recognize that various alternative methods exist to preserve the user's category/subcategory selection, including cookies, sessions, a separate database table, or a flat file.

### V. Displaying any Existing Text Segments

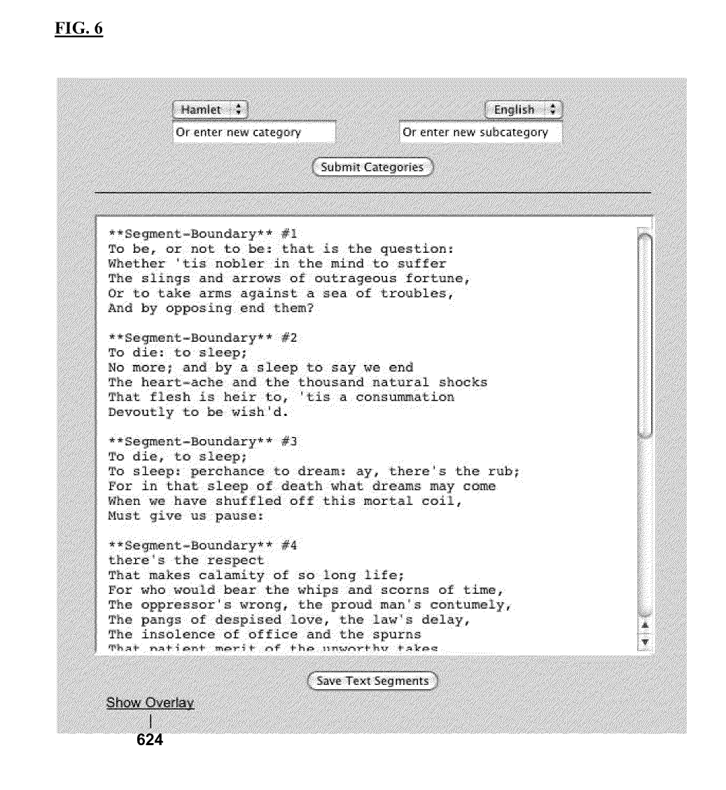

Upon receiving the Categories Form's data set, and as directed by the GUI File's server-side scripting instructions, the Server also queries the Database for any text segments already in the Text Segments Table that have been assigned to the category/subcategory combination chosen by the user. If any exist, the Server retrieves them from the Database and writes them to the Segments Form's textarea element, so that it will display the text segments (FIG. 6; Listing, lines 208-218), as described further below. If none exist, the Server leaves the GUI's textarea element alone, so that it will continue to display no contents (FIG. 3, 320; Listing, lines 208-218).

The Server then transmits the GUI's HTML, with any modifications directed by the server-side scripting operations described above, back to the user's Browser. The Browser in turn renders the GUI again for the user. (FIG. 3.)

### VI. Entering New Text and Segment Boundaries

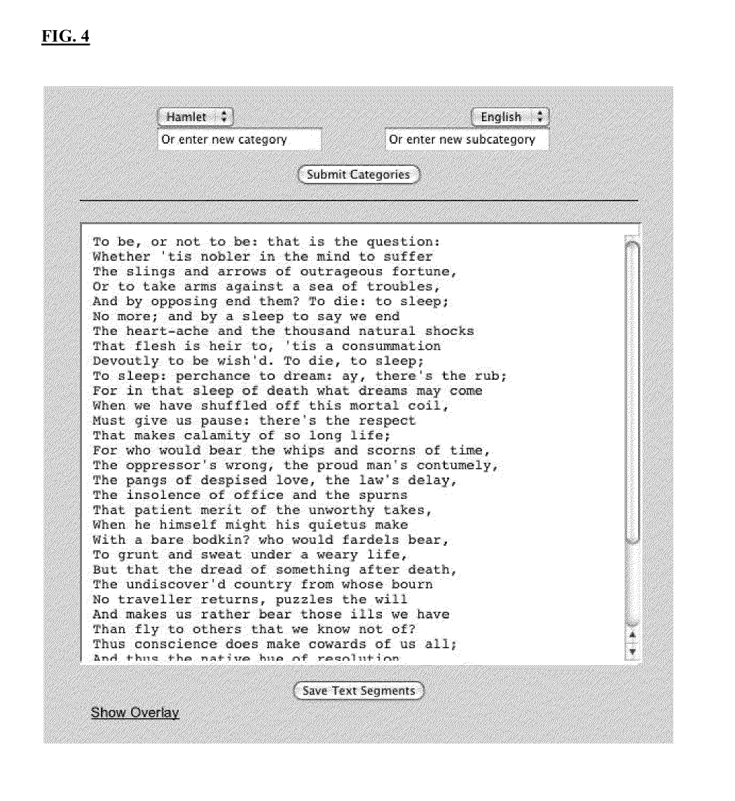

With a category/subcategory combination selected, the user may administer text segments for that combination. The user may type text into the textarea control of the Segments Form, as illustrated by FIG. 4. The user alternatively may input the text by various means other than typing, including by copying and pasting, importing, scanning and/or uploading it from another source.

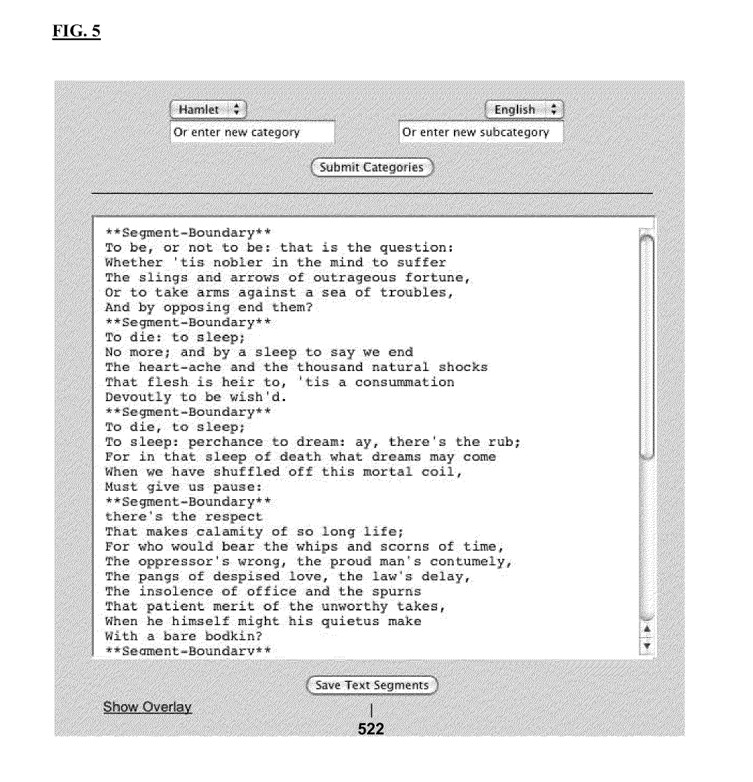

To indicate that text in the textarea should be processed as one or more discrete text segments to be saved to the Database, the user inserts a boundary marker before each intended segment, as shown in FIG. 5 where the exemplary boundary marker is the character sequence “**Segment-Boundary**”. The boundary marker is a distinct sequence of human readable characters. In preferred embodiments, it should be distinguishable from any character sequence a user would ever be likely to wish to save in the Database, but still be easy for humans to read and remember. In appropriate contexts, the character sequence “%-segment-%” could serve as a boundary marker, for example, as could “::boundary::”, “**slide**”, “/------/”, or other equivalents.

The boundary marker, when it appears in the textarea control element, indicates that all text that follows it should be interpreted and processed as a discrete text segment, unless and until it is followed by another boundary marker. Any succeeding boundary marker indicates the start of a succeeding text segment and, correspondingly, the end of the preceding text segment. Any and all text that precedes the first boundary marker in the textarea is ignored, and will not be loaded into the Database.

A user can enter a boundary marker by various methods, including by typing it, or by copying and pasting it, or shortcuts may be provided, including context menu or hotkey options.¹³ ¹³ A “context menu” (also called a contextual or popup menu) is a menu that appears upon user interaction with a graphical user interface element, such as by right clicking the element with a mouse, and offers one or more options that may be selected, one of which would be insertion of a boundary marker. A “hotkey” is a keyboard shortcut where the pressing of one or more predefined keys or key combinations would invoke insertion of the boundary marker.

### VII. Uploading Bounded Text Segments

By clicking the Segments Form's submit button control (522; Listing, lines 221-223), the user causes the Browser to transmit the Segments Form's data set to the GUI File on the Server as processing agent. The data set includes the values of the form's hidden input controls that memorialized the user's category/subcategory choice (Listing, lines 225-226, 228-229). It also includes any text the user entered into the Segments Form's textarea (FIG. 5).

Upon receiving the data set, the Server processes it as instructed by the GUI File's server-side scripts. The Server checks the values of the Segments Form's hidden category and subcategory controls (Listing, line 19) to make sure the user previously has made a category/subcategory choice and to obtain the values of that choice, if any. If the user has not made a choice (i.e., if the user has submitted the Segments Form without previously having submitted the Categories Form), the Server alerts the user to choose a category and subcategory.¹⁴ (Listing, lines 28-30.) ¹⁴ It will be apparent to those skilled in the art that this validation of the user's input can also be performed by the Browser, as instructed by a client-side script, after the user has submitted the Segments Form but before the Browser has transmitted its data set to the Server.

If the user already has made a category/subcategory choice, the Server deletes from the Database any text segments in the chosen category/subcategory combination. (Listing, line 21.) This is preparatory to replacing them with any text segments received via the textarea control.

The Server then checks the value of the Segments Form's textarea control. If text has been received via that control, the Server tokenizes and parses it based on any boundary markers it contains.¹⁵ (Listing, line 23.) All text following the first boundary marker, if any, is designated as the first text segment, until a second boundary marker, if any, is found. All text following the second boundary marker, if any, is then designated as the second text segment, until a third boundary marker, if any, is found. This process repeats until the end of any submitted text. The process can be accomplished by means of regular expression and string manipulation operations familiar to those with ordinary skill in the art. ¹⁵ A “token” is a discrete sequence of characters representing a distinct semantic entity. To “tokenize” a stream of text is to identify the tokens it contains. To “parse” a stream of text is to build a data structure based on its tokens.

The Server then inserts any and all text segments accumulated by the foregoing process into the Database's Text Segments Table 12. (Listing, line 24.) In doing so, it assigns to their category_id and subcategory_id fields in the Text Segments Table the values received via the Segments Form's hidden input fields (Listing, lines 225, 228). In the sequence_number field of the Text Segments Table 12, the Server also assigns the text segments a sequence number based on the order in which they were entered into the Segments Form's textarea.

If the user has submitted the Segments Form without entering any text in its textarea (or without including any boundary marker), no new text segments will be inserted into the Database, the end-result of which will be to erase any text segments for the chosen category/subcategory combination with which the Database already may have been populated. (Listing, line 21.) In various embodiments, if the Segments Form has been submitted in such a state, it will be desirable to require the user to confirm that he wishes to erase all pre-existing text segments for the chosen category/subcategory combination before the deletion operation is performed. It will be apparent to those with ordinary skill in the art how to use either server-side or client-side scripting instructions to implement such a confirmation constraint.

### VIII. Updating the GUI

After updating the Database in accordance with the data set received from the Segments Form, the Server updates the GUI's HTML and retransmits it to the user's Browser, which renders it and displays it to the user, as illustrated by FIG. 6.

As part of updating the GUI's HTML, the Server again writes the chosen category/subcategory combination in the Segments Form's hidden input fields (Listing, lines 225-226, 228-229) in order to maintain state.

The Server also writes the updated text segments, if any, to the Segments Form's textarea. (Listing, lines 210-216.) As illustrated in FIG. 6, the Server writes the text segments in order of their sequence numbers. Before each text segment, it also writes a boundary marker, and it appends to each boundary marker each new text segment's sequence number. When displayed to the user, the appended sequence numbers indicate that the text segments have been entered into the Database. They also help the user find specific text segments quickly and otherwise navigate among the text segments when reviewing them.

### IX. Iteration of Text Administration Process

With the Segments Form, the user may iterate the foregoing process to manage text segments. With ease, the user may add, change, reorder, or delete text segments for a specific category/subcategory combination. The Categories Form also makes it easy for the user to switch among the categories and subcategories of text segments the user wishes to administer, or to create new categories or subcategories.

### X. Measurement Overlay

For various embodiments, it will be desirable to provide a convenient facility to assist the user in measuring the size of text segments while the user is deciding where to place boundary markers. This would be the case, for example, if the user intends for the Database to support an application that displays text segments through viewing facilities of limited dimensions, such as mobile smartphone screens or narrow ticker-tape-style electronic media, or printed in ink at designated positions on paper forms.

Such a convenience may be provided by means of a facility for the GUI to display, at the user's option, what appears to the user to be a translucent overlay defining a subset of the Segments Form's textarea element. The overlay's position may remain static as the user scrolls through the textarea or inputs or deletes text within it. (As an alternative, the user may move the overlay while the text to be measured by it remains static.) The overlay's dimensions, in proportion to the font size and line height of the text displayed in the textarea, should be calibrated so as to match the parameters of the user's intended end-use for the text segments.

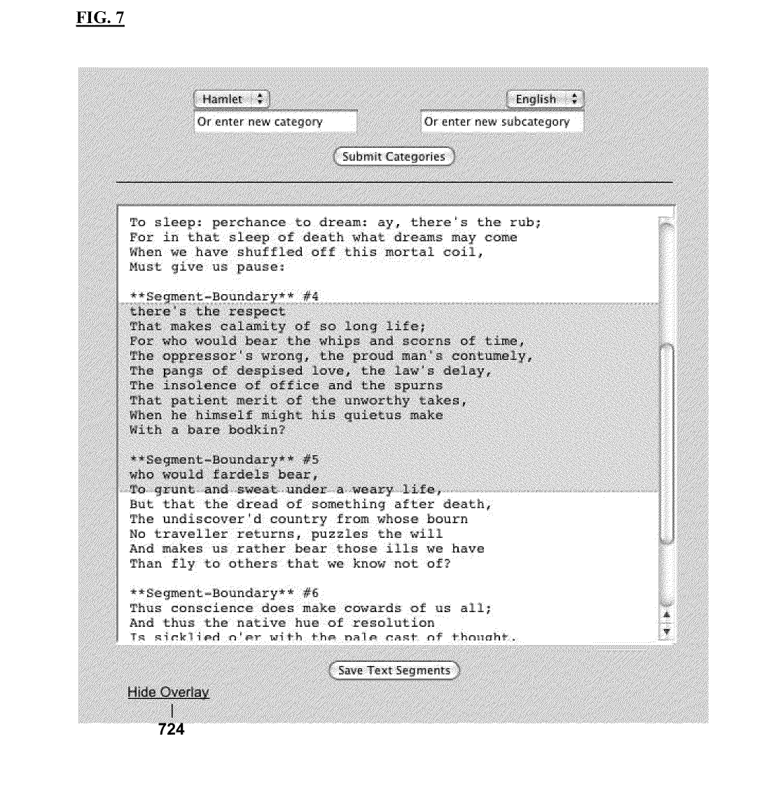

FIG. 6 shows an example of the GUI with a hyperlink toggle 624 that the user may click to display a measurement overlay. FIG. 7 shows an example of how the overlay appears after the user has activated the hyperlink toggle. It also shows how the message displayed by the hyperlink toggle 724 changes from its prior state 624 to inform the user that clicking the hyperlink again will cause the overlay to disappear (i.e., to return the GUI to the state shown in FIG. 6).

The code for the exemplary measurement overlay and hyperlink toggle is shown in the Listing, lines 52-63, 93-98, 131-134, 235-237, where it is specified by means of HTML and CSS. The overlay is an HTML element positioned to occupy appropriate common space with the textarea element on the X-Y axes. The overlay's width is equal to that of the textarea, but its height is shorter so that the textarea extends above and below the overlay.

Although the overlay, as rendered, appears to the user to rest on top of the textarea, it is coded so that its position in the Z-index stack is below that of the textarea (Listing, line 55).¹⁶ This is necessary so the user may type within the textarea in the common space it shares with the overlay on the X-Y plane. So that the overlay may still be seen, therefore, the textarea's “background-color” property is set to “transparent.” (Listing, line 88.) In addition, to achieve an appropriate visual effect, the overlay's opacity property is set between 0 and 1 for partial transparency, in this example to 0.3 (or 30% transparency).¹⁷ (Listing, line 54.) ¹⁶ See generally W3C, Cascading Style Sheets Level 2 Revision 1 (CSS 2.1) Specification, W3C Candidate Recommendation, §9.9 (Layered Presentation), Sep. 8, 2009, available at http://www.w3.org/TR/2009/CR-CSS2-20090908/visuren.html#layers (last accessed Mar. 14, 2010).¹⁷ See generally W3C, CSS Color Module Level 3, W3C Working Draft, §3.2 (Transparency), Jul. 21, 2008, available at http://www.w3.org/TR/css3-color/#transparency (last accessed Mar. 14, 2010).

The hyperlink toggle's operations are implemented by means of client-side scripting instructions. (Listing, lines 102-121, 236.) Activation of the hyperlink toggle alternately causes the measurement overlay to appear and disappear by altering the overlay element's “display” property. Id. Although the exemplary client-side scripting instructions in the Listing are written in javascript, those with ordinary skill in the art will recognize that equivalent functionality may be implemented with alternative facilities.

For the benefit of users who may intend that the text segments be put to a plurality of end-uses involving the display of text segments with varying display parameters, it is desirable to provide a plurality of measurement overlays. The size of each overlay would be calibrated to match one of the intended end-use cases, and each would be available to be displayed at the user's option.

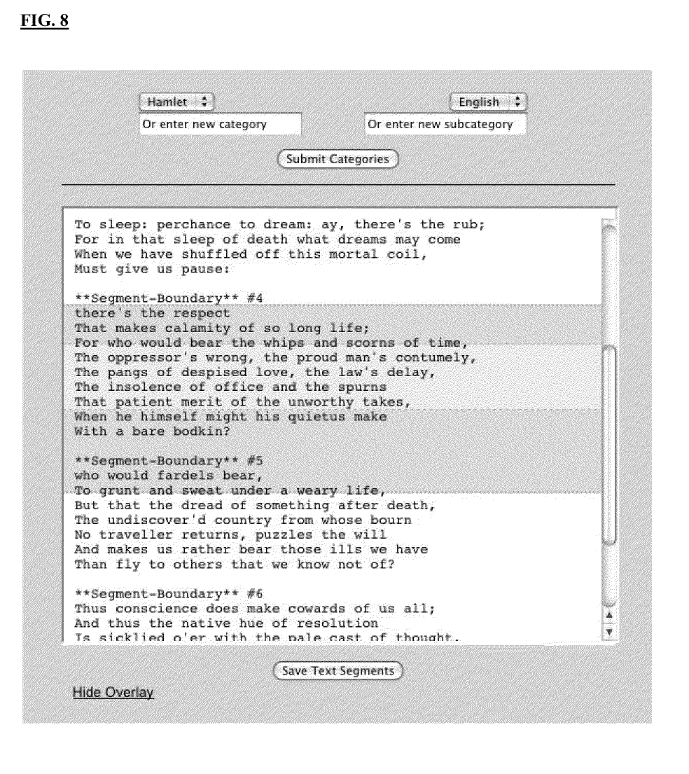

Alternatively, a plurality of reference marks or areas could be included at different points along the Y axis of a single overlay, with the placement of each one calibrated to match a different end-use case. An example of this is provided by FIG. 8 and the Listing at lines 58-63, 132-133. In some embodiments it also will be desirable to place reference marks or equivalent facilities for indicating a point or points along the X axis.

Similarly, it is desirable to provide the user with the option to adjust the overlay's dimensions, or the placement of its internal reference marks, so as to customize its calibration. Based on the explanation and examples provided herein, it will be apparent to one with ordinary skill in the art how to provide these further options.

As the present invention may be embodied in numerous forms without departing from its spirit or essential characteristics, it should be understood that above-described embodiments are not limited by any details of the description, but rather should be construed broadly within the invention's spirit and scope as defined in the appended claims, and therefore all changes and modifications that fall within the meets and bounds of the claims, or equivalence of such meets and bounds, are therefore intended to be embraced by the appended claims.

### COMPUTER PROGRAM LISTING

The following Computer Program Listing is submitted pursuant to 37 CFR §1.96. Pseudocode is distinguished from code by placing the former within square brackets (“[” and “]”).

<?php
[
if (categories form submitted) {

if (new category and/or subcategory created) {

add new category and/or subcategory to database;
update categories form to display selection(s);
update segments form to record selection(s) in hidden fields;

}
elseif (existing category and/or subcategory selected) {

update categories form to display selection(s);
update text_segments form to record selection(s) in hidden fields;

}
query database for text segments in chosen category/subcategory;
if (text segments exist) {

update text_segments form's textarea element to display segments;

}

}
elseif (text_segments form submitted) {

check state of text_segments form's hidden category/subcategory fields;
if (category/subcategory choice has been made) {

delete from database any pre-existing text segments in chosen category/subcategory;
if (new text received from textarea control) {

tokenize new text based on boundary markers and parse into new segments;
insert any new segments into database for chosen category/subcategory;
update text_segments form's textarea element to display new text segments;

}

}
else {

alert user to choose category/subcategory before submitting text_segments form;

}

}
]
?>
<!DOCTYPE HTML PUBLIC “-//W3C//DTD HTML 4.01//EN”
“http://www.w3.org/TR/html4/strict.dtd”>
<html>
<head>

<meta http-equiv=“Content-Type” content=“text/html; charset=utf-8” />
<style type=“text/css”>

#outer_wrapper

{ width: 600px; margin: 40px auto 0 auto; background-color: #D3D3D3; }

#inner_wrapper

{ width: 550px; margin: 0 auto; padding: 10px 35px 0 39px; position: relative; }

#overlay

```
{ width: 525px; height: 30%; position: absolute; top: 125px; left: 40px;
  margin: 100px 0; padding: 0; background-color: #808080; opacity: 0.3;
  z-index: 0; border-top: 2px dotted black; border-bottom: 2px dotted black;
  display: none; }
```

#overlay div:first-child

{ border-bottom: dashed 1px; height: 20%; width: 100%; }

#overlay div:last-child

{ border-bottom: dashed 1px; height: 35%; width: 100%; background-color:
#B8B8B8; }

#inner_categories_form

{ width: 400px; margin: 10px auto 13px auto; }

#inner_categories_form table

{ width: 375px; margin-left: −5px; }

#inner_categories_form td:first-child

{ text-align: left; }

#inner_categories_form td:last-child

{ text-align: right; }

#inner_categories_form div

{ width: 125px; margin: 10px auto 0 auto; padding: 0 17px 0 0; }

#text_segments_form

{ width: 525px; border-top: solid 1px; padding: 20px 0 0 0; }

#textarea_wrapper

{ background-color: white; }

#textarea_wrapper textarea

{ width: 515px; height: 400px; margin: 0 auto; padding: 10px 0 0 10px; overflow:
auto; background-color: transparent; position: relative; z-index: 1; }

#segments_submit

{ width: 125px; margin: 15px auto 0 auto; }

#toggle_wrapper

{ margin: 0; padding: 0; }

#message

{ margin: 0 0 0 50px; padding: 0 0 25px 0; font-family: arial; font-size: 10pt; text-
decoration: underline; }

</style>
<script type=“text/javascript”>

function measure( )
{

var overlay = document.getElementById(‘overlay’);
var message = document.getElementById(‘message’);
if (overlay.style.display == ‘inline’)
{

overlay.style.display = ‘none’;
message.innerHTML = ‘Show Overlay’;

}
else
{

overlay.style.display = ‘inline’;
message.innerHTML = ‘Hide Overlay’;

}

}

</script>

</head>
<body>

<div id=“outer_wrapper”>

<div id=“inner_wrapper”>
<div id=“overlay”>

<div></div>
<div></div>

</div>
<form name=“categories” id=“categories_form” method=“post”
action=“[uri_for_gui_file]”>

<div id=“inner_categories_form”>

<table>

<tr>

<td>

<select>

<?php
[
if (one or more $categories exist) {

echo ‘<option value=“none”>Choose Category</option>’ .
“\n”;
foreach ($categories as $category) {

if (user has selected $category) {

echo ‘<option value=category_id
selected=“selected”>’ . $category . ‘</option>’ . “\n”;

}
else {

echo ‘<option value=category_id>’ . $category .
‘</option>’ . “\n”;

}

}

}
else {

echo ‘<option value=“none” selected=“selected”>Choose
Category</option>’ . “\n”;

}
]
?>

</select>
<input type=“text” value=“Or enter new category”>

</td>
<td>

<select>

<?php
[
if (one or more $subcategories exist) {

echo ‘<option value=“none”>Choose Subcategory</option>’
. “\n”;
foreach ($subcategories as $subcategory) {

if (user has selected $subcategory) {

echo ‘<option value=subcategory_id
selected=“selected”>’ . $subcategory . ‘</option>’ .
“\n”;

}
else {

echo ‘<option value=subcategory_id>’ .
$subcategory . ‘</option>’ . “\n”;

}

}

}
else {

echo ‘<option value=“none” selected=“selected”>Choose
Subcategory</option>’ . “\n”;

}
]
?>

</select>
<input type=“text” value=“Or enter new subcategory”>

</td>

</tr>

</table>
<div>

<input type=“submit” value=“Submit Categories” />

</div>

</div>

</form>
<form name=“text_segments” id=“text_segments_form” method=“post”
action=“[uri_for_gui_file]”>

<div id=“textarea_wrapper”>

<textarea><?php

[
if (user has selected a category/subcategory combination) {

if (one or more $text_segments exist in selected category/subcategory) {

foreach ($text_segments as $text_segment) {

echo “<p>$boundary_marker #$sequence_number <br/> \n
$text_segment</p> \n”;

}

}
]

?></textarea>

</div>
<div id=“segments_submit”>

<input type=“submit” value=“Save Text Segments” />

</div>
<input type=“hidden” name=“category_id” value=“<?php [insert category_id value if
a category has been selected; otherwise set value to “none”] ?>” / >
<input type=“hidden” name=“subcategory_id” value=“<?php [insert subcategory_id
value if a subcategory has been selected; otherwise set value to “none”] ?>” />

</form>
</div> <!-- close “inner_wrapper” div-->
<div id=“toggle_wrapper”>

<p id=“message” onClick=“measure( );”>Show Overlay</p>

</div>

</div> <!-- close “outer_wrapper” div-->

</body>
</html>

What is claimed is:

1. A method of populating and managing a computer database of discrete, categorized segments of sequential text, comprising the steps of:
a. providing a computer database management facility within a computer-based operating environment that includes access to a recording medium operable for database storage;
b. configuring said database management facility to provide a database operable to
i. store a plurality of discrete text segments,
ii. store at least one category definition,
iii. store at least one member for each category definition, and
iv. associate each of said discrete text segments with a set including one member of each category definition, and with a sequence number that is shared by no other text segment associated with said set;
c. providing a means to populate said database with at least one category definition;
d. providing a means to populate said database with at least one member of each category definition; and
e. providing a means for an end-user to populate said database with a plurality of text segments, wherein
i. the end-user designates said set of one member of each category definition,
ii. the end-user presents to a processing facility a text passage that includes a marker signifying boundaries of said text segments, the marker being positioned at a plurality of intervals,
iii. the processing facility divides the text passage into text segments in accordance with said boundaries defined by positions of said marker,
iv. the processing facility populates said database with said text segments such that each text segment is associated with said set of one member of each category definition designated by the end-user, and
v. for each of said text segments, the processing facility populates the database with the sequence number that is associated with the text segment.

2. The method according to claim 1, wherein said sequence number that is associated with each text segment identifies the text segment's ordinal position within said text passage.

3. The method according to claim 1, further comprising a step wherein said means to populate said database with at least one category definition includes pre-populating the database with at least one category definition.

4. The method according to claim 1, further comprising a step wherein said means to populate said database with at least one category definition includes providing a means for the end-user to populate the database with at least one category definition.

5. The method according to claim 1, further comprising a step wherein said means to populate said database with at least one member of each category definition includes pre-populating the database with at least one member of at least one category definition.

6. The method according to claim 1, further comprising a step wherein said means to populate said database with at least one member of each category definition includes providing a means for the end-user to populate the database with at least one member of at least one category definition.

7. The method according to claim 1, wherein when said processing facility populates said database with said text segments associated with said set of one member of each category definition, the processing facility deletes from the database any text segments previously stored in association with said set of one member of each category definition.

8. The method according to claim 1, further comprising a step of providing a means to display to said end-user, in order of their sequence numbers, all text segments with which the database has been populated in association with a set of one member of each category definition.

9. The method according to claim 8, further comprising:
a. displaying said text segments to the end-user with each text segment preceded by said marker,
b. permitting the end-user to edit said displayed text segments and markers,
c. permitting the end-user to present the edited text segments and markers to said processing facility.

10. The method according to claim 1, further comprising:
a. providing a graphical user interface in a form of a text-display element within which the end-user may view, input, or edit text segments and markers prior to passing them to said processing facility, and
b. within said text-display element, providing a facility to assist the end-user in measuring the size of text segments.

11. The method according to claim 10, wherein said facility to assist the end-user in measuring the size of text segments comprises a graphical element including at least one of (a) a translucent overlay, (b) at least one region of distinct coloration, (c) at least one horizontal or vertical line, and (d) at least one reference mark.

12. The method according to claim 11, further comprising the step of providing the end-user with a means to cause said graphical element to appear and disappear.
